(19) United States
(12) Patent Application Publication
(10) Pub. No.: US 2007/0232234 A1
(43) Pub. Date: Oct. 4, 2007

(54) Method of wireless conversion by emulation of a non-wireless device

(76) Inventors: Frank Joseph Inzerillo, (US); Joshua Lindsay, (US); Wayne Eugene Miller, (US)

Correspondence Address: SignaLogix Inc., 304 Turquoise Street, Milpitas, CA, 95035, US

(21) Appl. No.: 11/566,237

(22) Filed: Dec. 4, 2006

Related U.S. Application Data
(60) Provisional application No. 60/744,018, filed on Mar. 31, 2006.

(51) Int. Cl. H04B 1/00

(52) U.S. Cl. 455/42

(57) ABSTRACT

An adapter, for converting a non-wireless accessory into a wireless one by emulating a portable audio and/or video player (such as an MP3 player). The adapter includes a housing containing a wireless receiver, and means to transmit received signal to a compatible dock for playback, in a manner which emulates the playback from said portable audio/video player.

This application claims the benefit of the following provisional application, which is hereby incorporated by reference in its entirety: U.S. Provisional App. No. 60/744,018, filed on 31 Mar., 2006.

### BACKGROUND OF THE INVENTION

The present invention relates generally to an adapter for use in a wireless communication application. More particularly, the invention relates to an adapter that converts a standard wired audio or video accessory into a wireless one by emulating a device such as a portable digital audio/video player.

Recently the popularity of portable digital audio/video players (MP3 players) has been growing. New wireless technology such as Bluetooth, 802.11, and Ultra Wideband (UWB), for example, have become a popular way to stream audio or video from a portable digital audio/video player (such as an Apple iPod™) to an audio amplification system and or a video display system.

The current state of the art of these types of wireless solutions provides for a transmitter that may be mounted directly to, or built into, the portable digital audio/video player and a receiver that receives the streamed audio or video and converts it for reproduction through an audio amplification system and/or a video display system.

FIG. 1 shows one such application for wireless audio streaming. The wireless transmitter 2 connects to portable audio player 3. The wireless receiver 1 connects to the input of a stereo system to allow wireless music streaming from the audio player.

Products of this sort are good single purpose products but lack the flexibility for use in different environments. For example, some people may wish to wirelessly stream digital audio in a car, a boat or to a set of wireless headphones.

Many accessories exist in the marketplace that allow the direct wired connection of portable digital audio/video players to various types of amplification and or video display systems. These include docking stations, which are intended to hold, charge and connect a portable device to a standard stereo input which allows the portable player to play music through an external amplification system while it is installed in the dock.

More elaborate docking stations are available for connecting portable audio/video players to a home theatre system.

Other wired accessories include cassette adapters and FM transmitters for connecting a portable audio player to a car stereo system for the purpose of playing the portable audio player's audio through the car's stereo system.

Each of these accessories described may utilize a standard dock connector of the type shown in FIG. 2 to allow the portable digital audio/video player to be connected. There is a huge installed base of these types of accessories that are designed to accommodate a specific model of a portable digital audio/video player.

If a consumer decides to adopt wireless technology to stream audio and/or video, he or she may be left with an expensive decision to make in regards to replacing current wired accessories such as the ones described herein with new single purpose wireless ones.

Thus, there exists a need for an adapter that converts a directly-attached accessory into a wireless device.

In the preferred embodiment, the adapter would emulate the portable digital audio/video player mechanically and electrically. For example, a wireless adapter to be used as an emulator for an Apple iPod™ would have the capabilities of plugging directly into accessories that were designed for the iPod™. The wireless adapter would emulate the iPod™ such that the accessory operates as if an actual iPod™ is attached. This enables wireless streaming of audio or video into the wired accessory.

### SUMMARY OF THE INVENTION

The present invention solves the above-described need. The present invention has for its object to provide a method for converting accessories that are designed for standard wired use into wireless accessories by emulating a portable audio/video player. To this end, an adapter in accordance with principles of the present invention is characterized by having an adapter that is mechanically and electrically compatible with the standard wired accessories to the extent that will allow it to be positioned conveniently and cleanly with no loose wires.

A further object of the present invention is to provide a means by which the batteries of the adapter can be charged by the wired accessory provided the capability exists in the wired accessory to charge the portable audio/video player.

### BRIEF DESCRIPTION OF THE DRAWINGS

FIG. 1 shows a Bluetooth transmitter/receiver pair, designed for wirelessly connecting a portable audio player to a home stereo. It consists of two components commonly referred to as the receiver 1 and the transmitter 2. The transmitter 2 attaches directly to the dock connector on a portable audio player 3. The receiver 1 attaches directly to an Audio amplification system such as a home stereo. The transmitter 2 allows the portable audio player 3 to stream audio wirelessly (via Bluetooth) to the receiver 1.

FIG. 2 is the Apple iPod™ dock. It provides various connectivity options (USB, Firewire, Audio Out), battery charging capabilities as well as mechanical support to hold the iPod™ upright.

FIG. 3 is a perspective view of one embodiment of the adapter. In this embodiment, the adapter 4 has the mechanical form factor of a reduced height Apple ipod nano™, and includes a dock connector 5. In this embodiment, the adapter 4 would be compatible mechanically and electrically with any wired accessory that is compatible with the Apple iPod™, and would add wireless capability to that accessory. The embodiment could also include the form factor of any other model of portable audio player to match other specific docks.

FIG. 4 is a perspective view of one embodiment of the adapter 4 in use in an Apple iPod HiFi™ home stereo unit 6. In this embodiment, the adapter 4 converts the Apple HiFi™ unit 6 (which was designed to attach the iPod™ directly) into a wireless unit. This allows the consumer to operate the iPod™ several dozen feet away from the home stereo unit.

FIG. 5 is a block diagram of prior art, showing schematically how a typical wired connection is made between a portable audio player 3 and a stereo system or other external playback means 6. The audio player is plugged into a dock 7, which may include a mechanical stand for the player 3, which is in turn connected to said stereo system.

FIG. 6 is a block diagram of prior art, showing schematically how a typical wireless connection, of the sort shown in FIG. 1, is made between a portable audio player 3 and a stereo system or other external playback means 6. The audio player 3 includes, or is plugged into, a Bluetooth transmitter 2. The Bluetooth transmitter 2 communicates wirelessly with a dedicated Bluetooth receiver 1, which is in turn connected via wires directly to said stereo system 6.

FIG. 7 is a block diagram of the preferred embodiment of the present invention, showing schematically how a wireless connection may be made from a portable audio player 3 through a Bluetooth transmitter 2 which may be connected to or integral with said player 3, to a receiver 4 which in turn plugs into an existing dock 7 in a manner which mechanically and electrically emulates the connection made by an audio player 3 with a dock connector 7 as shown in FIG. 5. Said dock 7 may be integral with or wired to a stereo system 6 for playback.

FIG. 8 shows the preferred embodiment of the invention employed in an iPod™ dock.

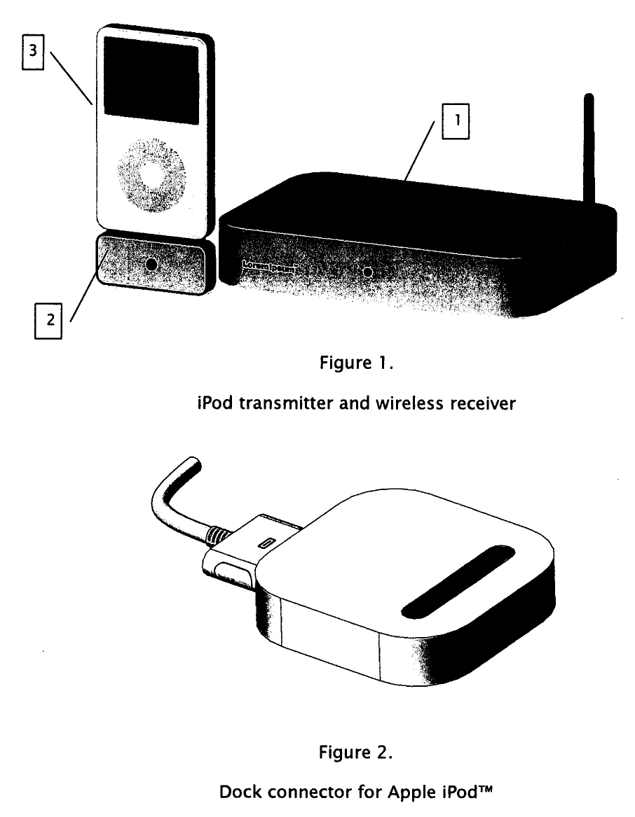

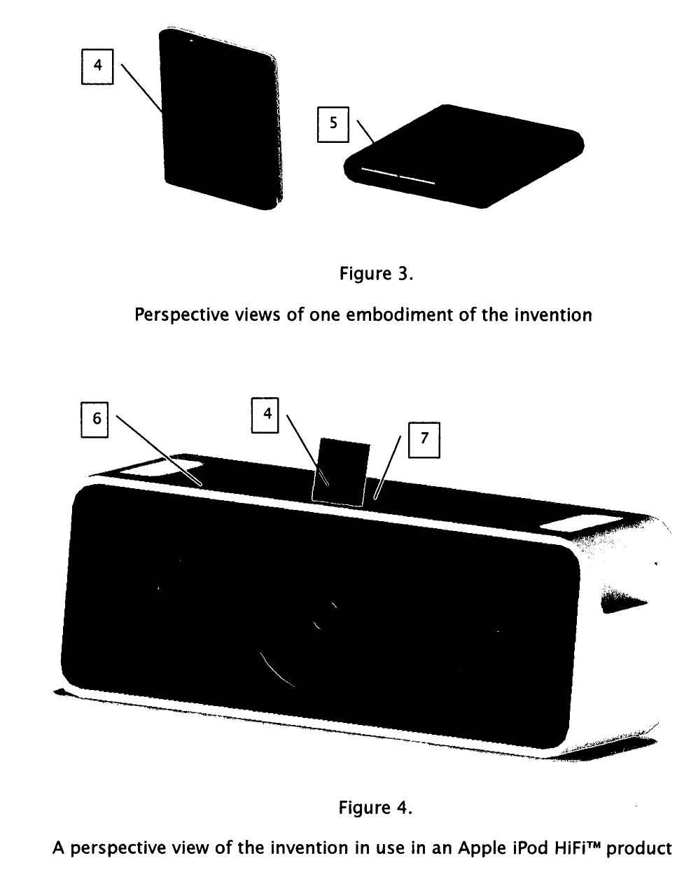

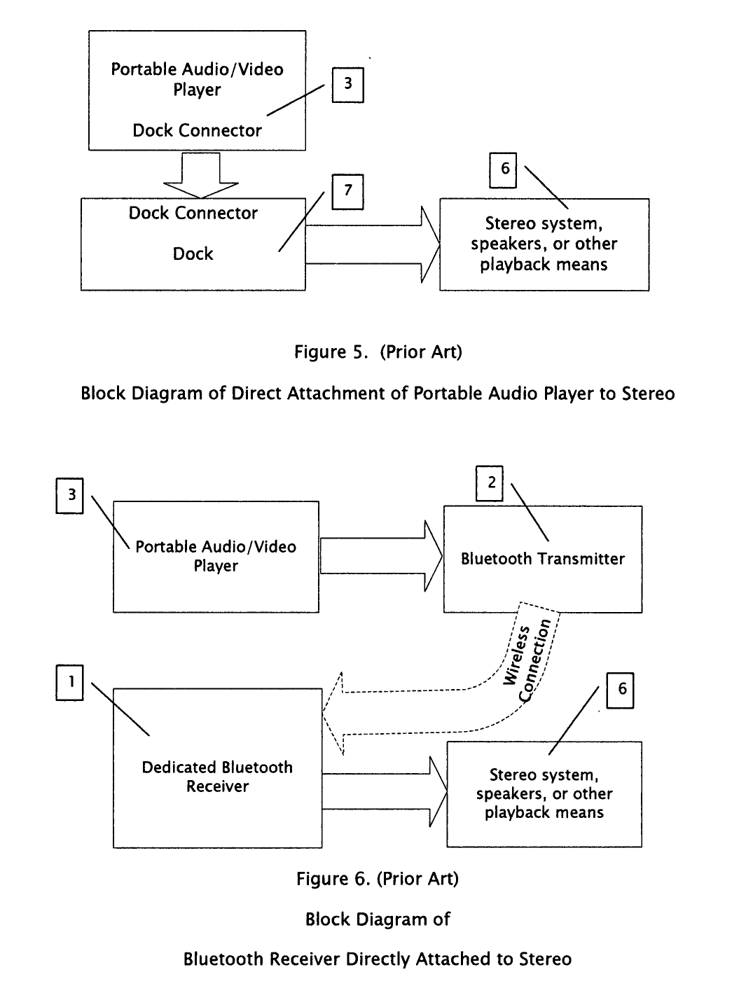

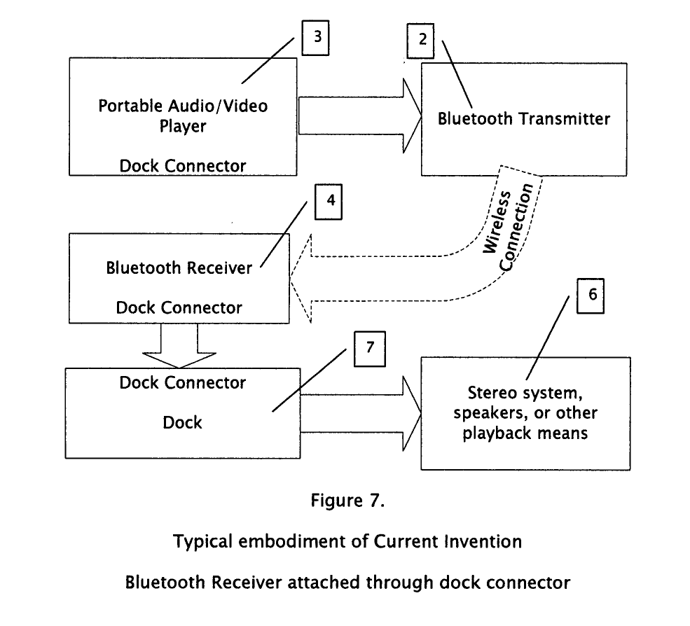

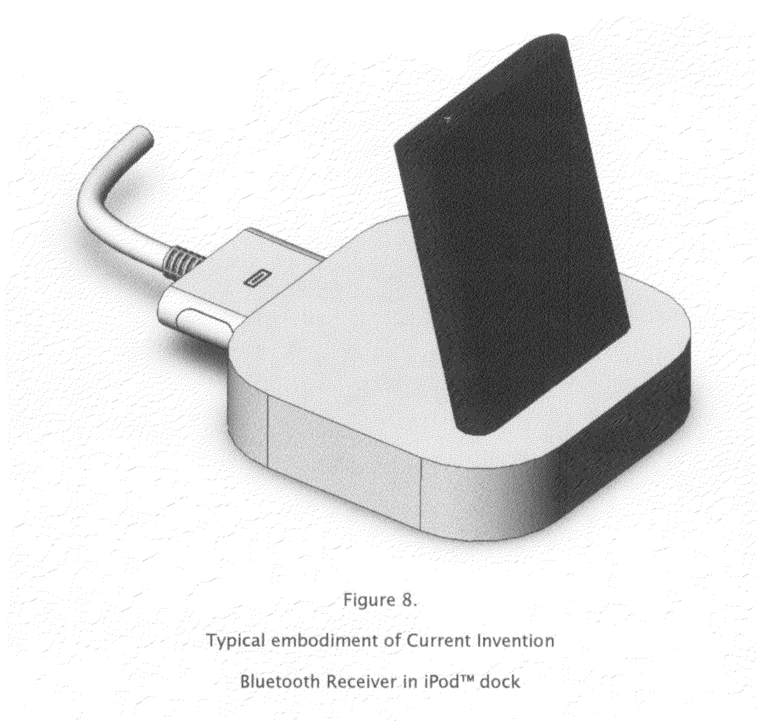

### DESCRIPTION OF THE PREFERRED EMBODIMENT OF THE INVENTION

An adapter, according to principles of the present invention, includes a housing having a configuration similar to that of a portable audio/video player that attaches to the wired accessory using the same methods as the actual portable audio/video player, and provides a wireless receiver for communication with the transmitter that resides on or is attached to the actual audio/video player or other wireless-transmitter-equipped device. The preferred embodiment may employ Bluetooth wireless protocol for communication with the portable audio/video device.

The adapter may be powered either by batteries or by the dock into which it is attached in a manner similar to that employed by the portable audio/video device that it emulates. communication with the transmitter that resides on or is attached to the actual audio/video player or other wireless-transmitter-equipped device. The preferred embodiment may employ Bluetooth wireless protocol for communication with the portable audio/video device.

The adapter may be powered either by batteries or by the dock into which it is attached in a manner similar to that employed by the portable audio/video device that it emulates.

What is claimed is:

1. An adapter for converting a non-wireless accessory into a wireless one by emulating a portable audio and/or video player (such as an MP3 player), the adapter comprising:
a. A wireless transceiver capable of pairing with another wireless transceiver which is attached to or integral with a portable audio/video device
b. A housing having a body which mimics the shape of a portable audio/video player such that it can be docked in any docking apparatus designed for docking with said audio/video player
c. A dock connector identical to that of said audio/video player such that the adapter can be electrically coupled to an audio/video target such as a docking apparatus or cable designed for coupling with said audio/video player
d. Analog output electronic reproduction means for Audio and/or video signal, to emulate the original audio/video player's output signals via said dock connector

2. The adapter of claim 1, wherein the adapter is in the form factor of a portable audio player such as an MP3 player
